(19) United States
(12) Patent Application Publication
(10) Pub. No.: US 2003/0149913 A1
(43) Pub. Date: Aug. 7, 2003

(54) Method and apparatus for efficient burn-in of electronic circuits

(76) Inventors: Hari Balachandran, Allen, TX (US); Scott Shaw, Plano, TX (US); Jayashree Saxena, Richardson, TX (US)

Correspondence Address: TEXAS INSTRUMENTS INCORPORATED, P O BOX 655474, M/S 3999, DALLAS, TX, 75265

(21) Appl. No.: 10/330,502

(22) Filed: Dec. 27, 2002

Related U.S. Application Data
(60) Provisional application No. 60/344,203, filed on Dec. 28, 2001.

(51) Int. Cl. H02H 3/05

(52) U.S. Cl. 714/30

(57) ABSTRACT

A method and apparatus to efficiently burn-in electronic circuits (30), where the electronic circuits (30) comprise at least one set of scan chains (18). The method of the invention comprises the steps of: coupling a scan-in channel to the input of each scan chain (18); coupling in parallel each output of each scan chain (18) to form a single compressed scan-out channel for each set of scan chains (18); applying a test data signal to each scan-in channel; and monitoring each signal from each compressed scan-out channel.

### CROSS-REFERENCE TO OTHER APPLICATIONS

This application claims priority from provisional application No. 60/344,203, filed on Dec. 28, 2001, the entirety of which is hereby incorporated by reference.

### TECHNICAL FIELD OF THE INVENTION

The present invention relates to electronic circuits and in particular to a method of efficiently burning-in electronic circuits that are comprised of scan chains and using a logic tree structure to monitor the output of each of the scan chains.

### BACKGROUND OF THE INVENTION

Ultra and very large scale integration techniques allow a large number of logic devices to be realized on a single device such as an integrated circuit. Such an integrated circuit may be difficult to test due to its complexity in relation to the limited access to circuit nodes provided by external device pins. Nonetheless it is normally possible to provide a functional test by driving device inputs with known test patterns, and monitoring outputs for a consistent response. In the case of combinatorial logic, a series of test patterns may be defined which fully exercises all possible device states to provide an exhaustive test which can form the basis of a practical test if the number of inputs is not excessive. For devices having storage elements the task can be significantly more complex, but by clocking elements to known states as part of testing, worthwhile test patterns are still possible. Unfortunately, the derivation of a substantially exhaustive test pattern can become a design exercise rivaling that of the device itself in complexity and represents a significant additional cost. Such costs can be prohibitive for low production quantities and a limitation in, for example, the application specific device market.

In an attempt to overcome this problem “Design for Test” (“DFT”) techniques have been developed. The goal of DFT techniques is to increase the controllability and observability of an integrated circuit. Controllability is the ability to place a logic high or a logic low at a particular node, while observability is the ability to propagate any errors to an observable output.

One DFT technique known in the art is the “scan design.” One form of a scan design is the “muxed-scan design”. In FIG. 1, a flip-flop 10 is shown with a “CLK” input, which is the clock signal input, a “D” input which is a functional data input, and a “Q” output which is the flip-flop data output, and may also be a driving input for combinatorial logic. Using the muxed-scan design, a flip-flop 10 as shown in FIG. 1 is converted to muxed-scan cell 12 as shown in FIG. 2a. The muxed-scan cell 12 is shown with a multiplexor designated as “mux”. The mux has three inputs, the D input, and a “Scan in” input which is a scan test data input into the flip flop, and an “S” input, which is the scan enable input and which allows for the selection between the D or the Scan in inputs. The output of the mux is coupled to an input of the flip-flop. The flip-flop of FIG. 2a also has a Q output. FIG. 2b shows a compacted version 14 of a muxed-scan cell. The compacted scan-cell 14 has at least the following inputs: (1) a D input; (2) a Scan in input; (3) an S input; and (4) a CLK input. In addition, each scan cell has at least a Q output which is a flip flop data output and driving input for the combinatorial logic. Other scan designs are known in the art, such as, but not limited to: level sensitive scan design (“LSSD”) and clocked scan design.

Several scan cells, such as the scan cell 14 shown in FIG. 2b, may be coupled to each other and to combinatorial logic to form a scan chain 18 as shown in FIG. 3. Electronic circuits, including integrated circuits, may have one or more such scan chains 18. The number of scan chains 18 in an integrated circuit is design dependant and tester limited. For instance in a typical Texas Instruments Inc. (“TI”) design eight (8) scan chains 18 are implemented in an integrated circuit 20 as shown in FIG. 4. Each of the scan chains 18 has an input that is coupled to a scan-in channel (SCANIN1-SCANIN8). Similarly each of the scan chains 18 has an output that is coupled to a scan-out channel (SCANOUT1-SCANOUT8). It should be noted that the scan chains 18 need not necessarily be part of an integrated circuit, but may be integrated into a variety of different electronic circuit designs known in the art.

The scan chains 18 may be exercised via a “burn-in.” A burn-in is a process by which device infant mortality rate may be accelerated through application of temperature and stress voltages for specific periods of time to the integrated circuits. Two different burn-in systems are known in the art, one is a non-monitored burn-in system which is capable of applying an input stimulus to the integrated circuits during the burn-in. The other is the monitored burn-in (“MBI”) which is capable of applying an input stimulus to the integrated circuits, and in addition is able to monitor the output signals from the integrated circuits.

Using an MBI allows one to obtain early failure rate (“EFR”) data directly from the burn-in oven. The burn-in oven fail data allows one to reduce burn-in time much faster than could be done with a full-blown, multi-readpoint EFR study. If the monitored burn-in data shows that all burn-in failures occur early in the burn-in cycle, the burn-in time may be shortened, thus improving throughput and reducing cost.

It would be very expensive to perform burn-in one device at a time. Therefore burn-in boards (“BIB”) are designed for optimum socket density. The goal is to have as many sockets possible without compromising performance. A balance had to be reached between the number of sockets based on the board real estate, number of burn-in oven drive signals used and resulting available monitor signals. The number of channels available for MBI may pose a limitation to the number of sockets on the burn-in board.

In order to maximize the number of sockets on the burn-in board, usually only one monitor signal is allocated per socket. Scan is implemented on designs to improve the controllability and observability of a circuit. The test vectors generated using scan techniques often have higher test coverage. Scan test vectors are often used to stress the logic portion of the device. Memory built-in self-test (“BIST”) is often used to test memories.

There are two different scan design techniques that are currently being used for burn-in. The first maintains parallel access to scan chain inputs and monitors only one of the scan chain outputs. Thus, as shown in FIG. 5, there is a scan in channel (SCANIN1-SCANIN8) coupled to each of the scan chains 18. However, only one scan chain output is coupled to a scan out channel SCANOUT1. Though this implementation does not require any special test mode design for burn-in, the problem with this implementation is the inability to monitor all of the scan chain outputs which reduces the collection and efficient usage of the fail data.

The second known scan design is one where the scan chains 18 are coupled into one long scan chain as shown in FIG. 6. A separate test mode is required to achieve such an architecture unless the scan design is arranged to have only one scan chain. As shown, the architecture provides only one scan input and one scan output to monitor and the implementation requires a special test mode design for burn-in. The problem with this implementation is the reduction in the number of vectors that can be loaded on to the tester thereby decreasing coverage. Though it is possible to monitor all fail data through the single scan output, this scan design implementation has a negative impact on burn-in and is inconsistent with the burn-in goal. The goal of burn-in is to exercise each node in the design as many times as possible. The limitation in burn-in tester memory limits the number of vectors that can be loaded. The above design requires as much as 8 times as many clock cycles for one scan vector compared to the design for burn-in methodology shown in FIG. 5, assuming that the number of scan chains is 8.

Based on the foregoing, it may be appreciated that a means of overcoming the disadvantages associated with prior art burn-in systems would be advantageous.

### SUMMARY OF THE INVENTION

Disclosed is a method to efficiently burn-in electronic circuits, where the electronic circuits comprise at least one set of scan chains. The method comprising the steps of: coupling a scan-in channel to the input of each scan chain; coupling in parallel each output of each scan chain to form a single compressed scan-out channel for each set of scan chains; applying a test data signal to each scan-in channel; and monitoring each signal from each compressed scan-out channel.

Also disclosed is an integrated circuit burn-in apparatus. The integrated circuit burn-in apparatus comprises: a logic module comprising a first plurality of scan chains, each scan chain comprising an input and an output; an IP core comprising a second plurality of scan chains, each scan chain comprising an input and an output; a plurality of scan-in channels, where each input of first plurality of scan chains and each input of second plurality of scan chains are both coupled to one scan-in channel; a first logic tree that couples in parallel each output of the first plurality of scan chains to one first compressed scan-out channel; and a second logic tree that couples in parallel each output of the second plurality of scan chains to one second compressed scan-out channel.

The invention also includes an electronic circuit burn-in apparatus comprising: a burn-in test unit, the burn-in test unit comprising: a burn-in oven; a heat source; a heat controller; and at least one burn-in board adapted to fit into the burn-in oven, the burn-in board comprising at least one removably attachable electronic circuit. The removably attachable electronic circuit comprising: at least one plurality of scan chains, each scan chain comprising an input and an output; a plurality of scan-in channels, where each input of each plurality of scan chains is coupled to one scan-in channel of the plurality of scan-in channels; and at least one logic tree that couples in parallel each output of each scan chains to one compressed scan-out channel.

An advantage of the invention is that it allows for the monitoring of each of a plurality of scan chains on an electronic circuit.

Another advantage of the invention is that the use of XOR gates to monitor each of the scan chains does not require extensive modifications to the electronic circuit.

### BRIEF DESCRIPTION OF THE DRAWINGS

The novel features believed characteristic of this invention are set forth in the appended claims. The invention itself, however, as well as a preferred mode of use, further objects, and advantages thereof, will best be understood by reference to the following detailed description of an illustrative embodiment when read in conjunction with the accompanying drawings.

FIG. 1 is an illustration of a flip-flop;

FIGS. 2a & 2b are illustrations of muxed-scan cells;

FIG. 3 is an illustration of a scan chain;

FIG. 4 is an illustration of an integrated circuit with eight scan chains;

FIG. 5 is an illustration of a prior art parallel input scan design;

FIG. 6 is an illustration of a prior art series scan design;

FIG. 7 is an illustration of an apparatus for efficiently burning-in a plurality of scan chains;

FIG. 8 is an illustration of an apparatus for efficiently burning-in an integrated circuit with a logic module and an IP core; and

FIG. 9 is an illustration of a burn-in test unit.

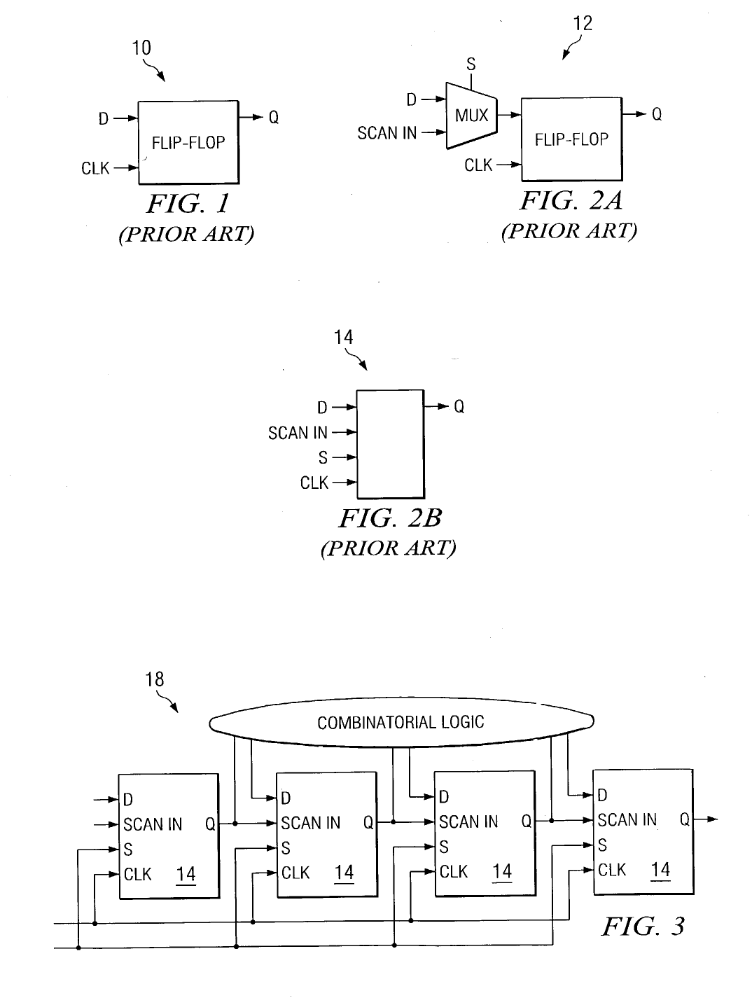

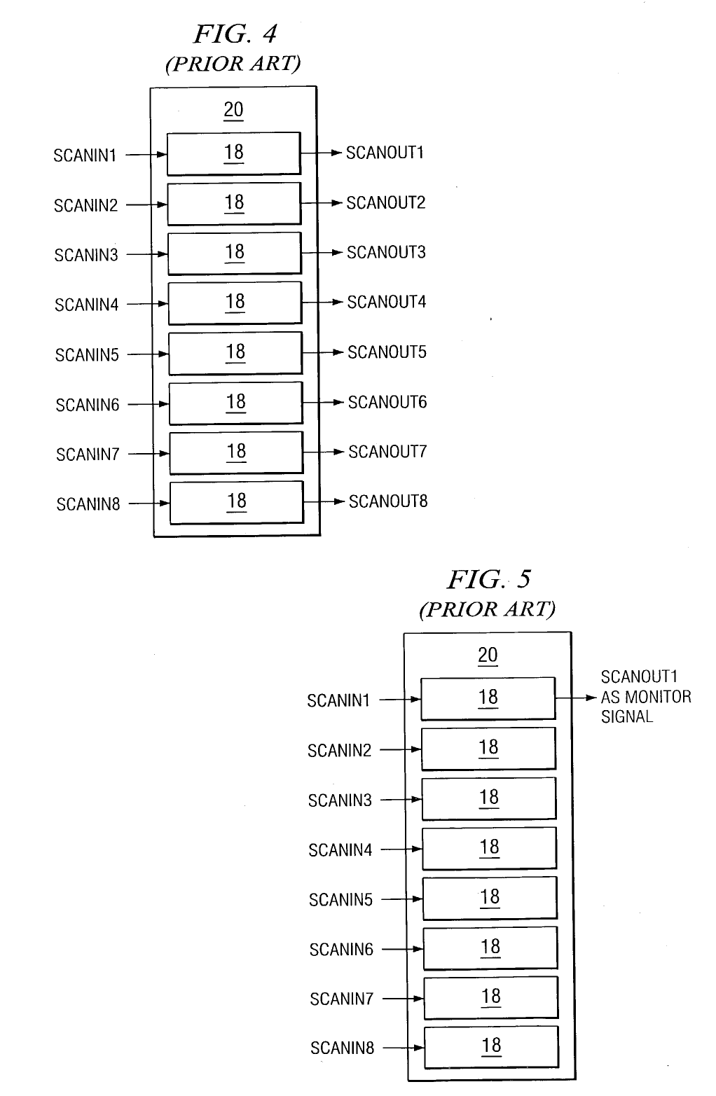

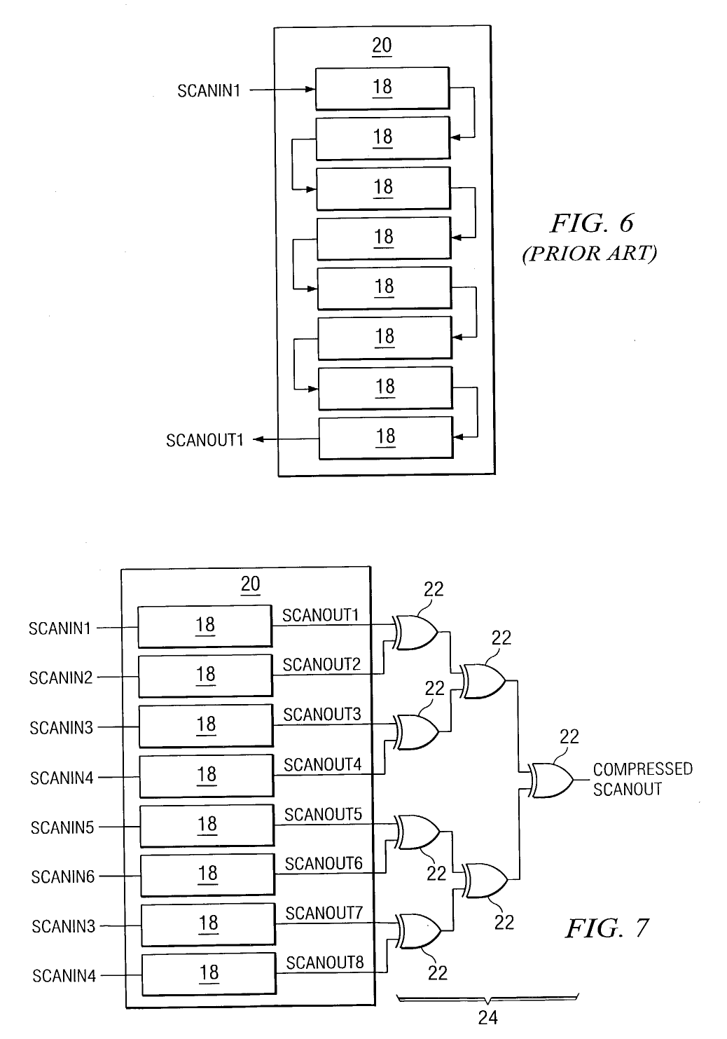

### DETAILED DESCRIPTION OF THE PREFERRED EMBODIMENTS

The invention addresses at least two disadvantages associated with the prior art methods of testing scan chains 18. Referring to FIG. 7, an integrated circuit 20 is shown with 8 scan chains 18 . Each pair of scan chains 18 are coupled in parallel to a logic gate 22. Each pair of logic gates 22 are coupled in parallel to another logic gate 22, and the last pair of logic gates 22 are coupled in parallel to a final single logic gate 22, where the output is coupled to a compressed scanout channel. These 7 logic gates form a logic tree 24. Each plurality of scan chains coupled to separate logic trees may be referred to as a “set” of scan chains.

In FIG. 7 the logic gates are shown as XOR gates, but other combinational logic may be used. Due to the parallel nature in which outputs from the scan chains 18 are coupled, parallel access to the outputs is maintained to each of the scan chains 18. Thus all the chains can be monitored as shown in FIG. 7, which allows for an “efficient” monitored burn-in. It is “efficient” because the invention will significantly increase the collection of monitored data with very little modification to the design. For example, XOR tree structures can be implemented with insignificant design resources and time. The monitored data collected from the compressed scanout channel may be used in re-designing future burn-ins.

Aliasing may be a concern arising from the compressing or compacting of signals from the eight scanout channels (Scanout1-Scanout8). The disclosed invention has insignificant aliasing effects. Aliasing will occur only if all the following conditions are satisfied simultaneously.

1. Even parity failure occurring on a particular cycle on different chains (e.g. 2 chains failing at a particular cycle instead of 3 chains failing at the same cycle);

2. Failure occurs at the same cycle (e.g. cell location 2 on two chains);

3. Even number of failures occurs at a given cycle location for the entire length of the scan chain. (e.g. assuming failures occurring at cell locations 2, 3, 10, 200 etc. on one chain, then an even number of failures has to occur at the same locations with the inclusion of the above failure. It does not matter if different chains fail at different locations but the parity at any given cycle should be an even number.)

4. Failures occurs at the same cycle location for the entire length of scan vectors.

The probability of all the above conditions being satisfied simultaneously is negligible.

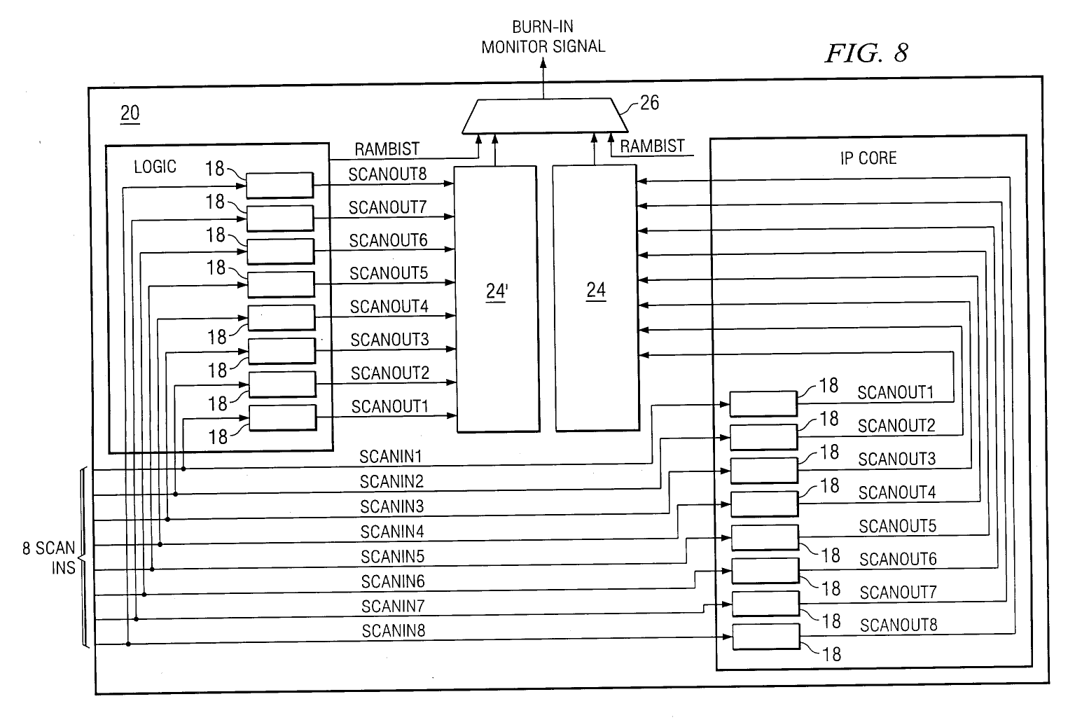

FIG. 8 illustrates a design implementation for a scan-out chain according to the invention. On the integrated circuit 20 are eight (8) scan in channels designated Scanin1-Scanin8. Designated as IP core is a logic core, which may comprise a pre-designed logic core such as BSP core. In the IP core are eight (8) scan chains 18. Channels Scanin1-Scanin8 are coupled to the inputs of the eight (8) scan chains 18 on the IP core. Coupled to the output of the eight (8) scan chains 18 are the scan out channels designated Scanout1-Scanout8. Those scan out channels (Scanout1-Scanout8) are coupled to a first logic tree 24, in the same manner as shown in FIG. 7. The output of the logic tree 24 is coupled to an input of the 4 to 1 multiplexor 26.

Still referring to FIG. 8, also on the integrated circuit 20 is a module designated as Logic which may be comprised of ASIC logic and RAMs. The Logic module may be comprised of eight (8) scan chains 18. The eight (8) scan in channels (Scanin1-Scanin8) are also coupled to the inputs of the eight (8) scan in chains in the Logic module. The outputs of the eight (8) scan chains 18 on the Logic module are coupled to eight (8) scan out channels designated Scanout1-Scanout8. Those Scanout1-Scanout8 channels are coupled to a second logic tree 24′, in the same manner as shown in FIG. 7. The output of the logic tree 24′ is coupled to another input of the 4 to 1 multiplexor 26.

FIG. 8 also shows a RAM built-in-self test channel designated Rambist1 coupling the IP core to the input of the multiplexor 26 and a RAM built-in-self test channel designated Rambist2 coupling the Logic module to another input of the multiplexor 26. The output of the multiplexor 26 is the burn-in monitor signal channel.

Still referring to FIG. 8, it can be seen that during scan testing of the integrated circuit, the multiplexor may transmit just one signal from the four (4) input channels Rambist1, Rambist2, the channel from the Logic Module and the channel from the IP Core. However, irrespective of which channel is being monitored at any given time, all of the components supplying signals to the multiplexor 26 (the RAMs, Logic Core, and IP Core) may be “exercised” during the scan test. This is consistent with the burn-in principle of testing each node as many times as possible.

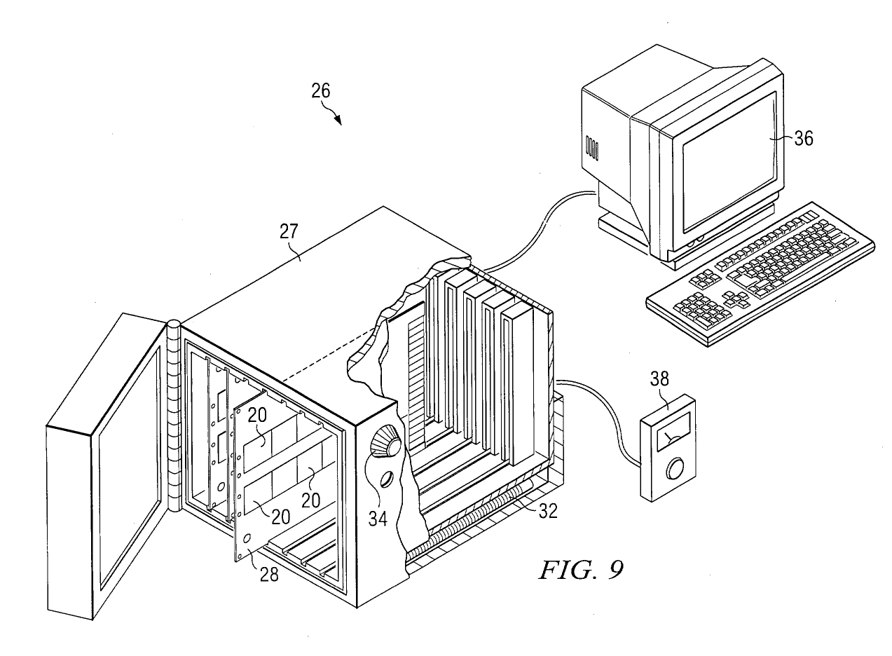

Referring to FIG. 9, a burn-in test unit 26 is shown. The burn-in test unit 26 comprises a burn-in oven 27 that is adapted to receive a burn-in board 28. The electronic circuits 20, which may include integrated circuits, to be tested are shown on the burn-in board 28. The electronic circuits 20 may be attached to the burn-in board by methods known in the art, such as, but not limited to, sockets, connectors, plugs and pins. The burn-in test oven 27 includes a heat source 32, and a heat controller 34 for adjustably controlling the amount of heat generated by the heat source 32. As is known in the art, a much more strenuous burn-in test is obtained when a signal is provided to a circuit being tested (when the circuit is actually caused to operate to perform the input and output functions that it is designed to perform) than when only a voltage bias is provided to the circuit (when a voltage source is connected to the circuit, but the circuit is not required to operate). While various other means could be employed, in the illustrated embodiment, the controller means comprises a computer 36 and, if necessary, an external voltage bias source 38.

The embodiments and examples set forth herein are presented in order to best explain the present invention and its practical application and to thereby enable those skilled in the art to make and utilize the invention.

Those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method to efficiently burn-in electronic circuits, said electronic circuits comprising at least one set of scan chains, the method comprising the steps of:
coupling a scan-in channel to the input of each scan chain;
coupling in parallel each output of said each scan chain to form a single compressed scan-out channel for each said set of scan chains;
applying a test data signal to each said scan-in channel;
monitoring each signal from each said compressed scan-out channel.

2. The method of claim 1 where said step of coupling in parallel further comprises the step of:
using a logic tree to couple in parallel each output of said at least one scan chain for each set of scan chains to a single compressed scan-out channel.

3. The method of claim 2 where said step of using a logic tree further comprises the step of:
using XOR gates to form each said logic tree.

4. The method of claim 1 further comprising the step of:
burning-in said electronic circuits.

5. The method of claim 1 further comprising the step of coupling each compressed scan-out channel to the input of a multiplexor.

6. The method of claim 5 further comprising the step of coupling at least one RAM built-in-test channel to the input of said multiplexor.

7. The method of claim 6, where said step of monitoring each signal comprises the step of:
selecting each input to said multiplexor for an amount of time during burn-in.

8. An integrated circuit burn-in apparatus comprising:
a logic module comprising a first plurality of scan chains, and where each scan chain of said first plurality of scan chains comprises an input and an output;
an IP core comprising a second plurality of scan chains, and where each scan chain of said second plurality of scan chains comprises an input and an output;
a plurality of scan-in channels, where each input of first plurality of scan chains and each input of second plurality of scan chains are both coupled to one scan-in channel of said plurality of scan-in channels;
a first logic tree that couples in parallel each output of said first plurality of scan chains to one first compressed scan-out channel; and
a second logic tree that couples in parallel each output of said second plurality of scan chains to one second compressed scan-out channel.

9. The integrated circuit burn-in apparatus of claim 8 further comprising:
a multiplexor comprising a first input that couples to said first compressed scan-out channel, a second input that couples to said second compressed scan-out channel, and one burn-in monitor output.

10. The integrated circuit burn-in apparatus of claim 8 further comprising:
a first RAM built-in-self-test channel coupled to said logic module;
a second RAM built-in-self-test channel coupled to said IP core;
a multiplexor comprising a first input that couples to said first RAM built-in-self-test channel, a second input that couples to said second RAM built-in-self-test channel, a third input that couples to said first compressed scan-out channel, a fourth input that couples to said second compressed scan-out channel, and one burn-in monitor output.

11. The integrated circuit burn-in apparatus of claim 8 wherein said first and second logic trees comprise XOR gates.

12. An electronic circuit burn-in apparatus comprising:
a burn-in test unit, said burn-in test unit comprising:
a burn-in oven;
a heat source;
a heat controller; and
at least one burn-in board adapted to fit into said burn-in oven, said at least one burn-in board comprising at least one removably attachable electronic circuit;
said at least one removably attachable electronic circuit comprising:
at least one plurality of scan chains, and where each scan chain comprises an input and an output;
a plurality of scan-in channels, where each input of each plurality of scan chains are coupled to one scan-in channel of said plurality of scan-in channels;
at least one logic tree that couples in parallel each output of each at least one plurality of scan chains to one compressed scan-out channel.

13. The electronic circuit burn-in apparatus of claim 12 wherein said at least one logic tree comprises XOR gates.

14. An integrated circuit burn-in apparatus comprising:
a burn-in test unit, said burn-in test unit comprising:
a burn-in oven;
a heat source;
a heat controller; and
at least one burn-in board adapted to fit into said burn-in oven, said at least one burn-in board comprising at least one removably attachable integrated circuit;
said at least one removably attachable integrated circuit comprising:
a logic module comprising a first plurality of scan chains, and where each scan chain of said first plurality of scan chains comprises an input and an output;
an IP core comprising a second plurality of scan chains, and where each scan chain of said second plurality of scan chains comprises an input and an output;
a plurality of scan-in channels, where each input of first plurality of scan chains and each input of second plurality of scan chains are both coupled to one scan-in channel of said plurality of scan-in channels;
a first logic tree that couples in parallel each output of said first plurality of scan chains to one first compressed scan-out channel; and
a second logic tree that couples in parallel each output of said second plurality of scan chains to one second compressed scan-out channel.

15. The integrated circuit burn-in apparatus of claim 14 further comprising:
a multiplexor comprising a first input that couples to said first compressed scan-out channel, a second input that couples to said second compressed scan-out channel, and one burn-in monitor output.

16. The integrated circuit burn-in apparatus of claim 14 further comprising:
a first RAM built-in-self-test channel coupled to said logic module;
a second RAM built-in-self-test channel coupled to said IP core;
a multiplexor comprising a first input that couples to said first RAM built-in-self-test channel, a second input that couples to said second RAM built-in-self-test channel, a third input that couples to said first compressed scan-out channel, a fourth input that couples to said second compressed scan-out channel, and one burn-in monitor output.

17. The integrated circuit burn-in apparatus of claim 14 wherein said first and second logic trees comprise XOR gates.

18. An apparatus for the efficient burn-in of integrated circuits, said integrated circuits comprising at least one scan chain, the apparatus comprising:
means for coupling one scan-in channel to the input of each of said at least one scan chain;
means for coupling in parallel each output of at least one scan chain to a single compressed scan-out channel;
means for applying a test data signal to each said scan-in channel;
means for monitoring the signal from said compressed scan-out channel.

19. An apparatus for the efficient burn-in of integrated circuits, said integrated circuits comprising at least one scan chain, the apparatus comprising:
means for coupling one scan-in channel to the input of each of said at least one scan chain;
means for coupling in parallel each output of at least one scan chain to a single compressed scan-out channel;
means for applying a test data signal to each said scan-in channel;
means for monitoring the signal from said compressed scan-out channel.
